(19) United States
(12) Patent Application Publication
(10) Pub. No.: US 2013/0131218 A1
(43) Pub. Date: May 23, 2013

(54) INSULATION FOR ROTATING ELECTRICAL MACHINES

(71) Applicants: Peter Gröppel, Erlangen (DE); Christian Meichsner, Buttenheim (DE); Igor Ritberg, Furth (DE)

(72) Inventors: Peter Gröppel, Erlangen (DE); Christian Meichsner, Buttenheim (DE); Igor Ritberg, Furth (DE)

(21) Appl. No.: 13/812,954

(22) PCT Filed: Jun. 30, 2011
(86) PCT No.: PCT/EP2011/061036

§ 371 Date: Jan. 29, 2013

(30) Foreign Application Priority Data
Jul. 29, 2010 (DE) 10 2010 032 555.4

(51) Int. Cl. H01B 3/40

(52) U.S. Cl. CPC H01B 3/40
USPC 523/456

(57) ABSTRACT

A mica-based insulation based on impregnating resin for rotating electrical machines is provided. The mica-based impregnating resin includes an epoxy resin/anhydride mixture and a nanoparticulate filler, wherein the nanoparticulate filler is a nanoparticulate silicon dioxide and/or aluminum oxide modified by a silanizing reagent. Further, a method of producing the mica-based impregnating resin is provided.

### CROSS REFERENCE TO RELATED APPLICATIONS

This application is the US National Stage of International Application No. PCT/EP2011/061036 filed Jun. 30, 2011, and claims the benefit thereof. The International Application claims the benefits of German Patent Application No. 10 2010 032 555.4 DE filed Jul. 29, 2010. All of the applications are incorporated by reference herein in their entirety.

### FIELD OF INVENTION

The invention relates to an insulation for rotating electric machines based on impregnating resins having a nanoparticulate filler.

### BACKGROUND OF INVENTION

In rotating electric machines such as motors or generators, what is decisively responsible for their operating safety is the reliability of the insulating system. The function thereof is to permanently insulate electric conductors (wires, coils, rods) from each other and from the laminated stator core or the surroundings. A distinction is made within high-voltage insulation between the insulation provided between strands (strand insulation), between the conductors or, as the case may be, turns (conductor or, as the case may be, interturn insulation), and between the conductor and ground potential in the slot-cap and winding-head region (main insulation). The thickness of the main insulation is matched both to the machine's rated voltage and to the operating and production conditions. The competitiveness of systems for generating energy and their distribution and use are crucially dependent on the materials used and technologies employed for insulating.

The problem associated with insulators thus subjected to an electric load is to be found in their being eroded owing to partial discharging, with what are called “treeing” channels being formed that result ultimately in the insulator's electric breakdown. Against that background, the prior art is for mica-based insulators to be used for permanently insulating the live conductors of the stators in rotating machines (motors, generators, turbo generators, hydro-electric generators, wind-power generators). Laminated mica insulators are currently employed for high- and medium-voltage motors and generators. Mica tapes are therein wound around the form-wound coils produced from the insulated strands and said coils then impregnated with synthetic resin primarily through a vacuum-pressure process (VPI=vacuum pressure impregnation). Mica in the form of mica paper is therein employed, with the cavities between the individual particles in the mica paper being filled with resin within the scope of impregnating. The bonding between the impregnating resin and mica substrate provides the insulation's mechanical strength. Its electric strength ensues from the multiplicity of solid-solid interfaces in the mica employed. The thus created layering of organic and inorganic materials forms microscopic interfaces whose resistance to partial discharges and thermal stress is determined by the properties of the mica platelets. Through the complex VPI process even the smallest cavities in the insulation have to be filed with resin in order to minimize the number of internal gas-solid interfaces.

The use of nanoparticulate fillers is described for additionally improving the resistance. It is known from the pertinent literature (and from the experience gained from using mica) that inorganic particles, in contrast to polymeric insulating materials, are not, or only to a very limited degree, damaged under the impact of partial discharging or destroyed thereby. The consequent erosion-inhibiting effect is therein dependent on, inter alia, particle diameter and the particle surface area resulting therefrom. It proves therein to be the case that the larger the specific surface area of the particles is, the greater the erosion-inhibiting effect will be on the particles. Inorganic nanoparticles have very large specific surface areas of 50 g/m² or more.

Known systems have the following disadvantages: the impregnating resin's viscosity is increased by the use of nanoparticulate fillers, as a result of which the mica is rendered more difficult to thoroughly impregnate.

The specific surface area of the nanoparticles initiates (partial) polymerizing of the impregnating resin during storage and while the process is being performed, as a result of which its viscosity greatly increases so that the mica is rendered additionally more difficult to impregnate.

For example the initial viscosity in the standard system (BADGE/anhydride) is approximately 15 to 20 mPas (at 60° C.). At a nanoparticle fill level of approximately 23% by weight, as is necessary to achieve a significant improvement in electric strength, viscosity increases to values >80 mPas, thus rendering the mica more difficult to impregnate especially when said value increases over time through the system's being stored.

### SUMMARY OF INVENTION

An object is to provide a composite material for impregnating mica-based insulators, which material has relatively low viscosity, preferably less than 50 mPas, in particular as its initial viscosity, despite the use of a nanoparticulate filler. Said object is disclosed by the subject matter of the claims in correlation with the description and figures.

The general discovery of the invention is that the reactivity of the nanoparticles compared with the matrix as a whole decisively influences the viscosity thereof

Thus what could be found was that the use of modified nanoparticulate silicon dioxide in epoxy resin/anhydride mixtures for producing impregnating resins for mica-based insulators keeps viscosity, particularly the initial viscosity at high fill levels, relatively low if one or more silanizing reagents are used as a modification of nanoparticulate silicon dioxide and/or aluminum oxide. Said reagents preferably have at least one functional group that reacts with the particle surface by separating off

In the impregnating resin there is preferably an epoxy resin/anhydride mixture containing an nanoparticulate filler in the amount of 3 to 60% by weight, in particular 5 to 40% by weight.

For example compounds selected from the following group serve as silanizing reagents:

Trimethyl-methoxysilane, methyl-hydrogendimethoxysilane, dimethyl-dimethoxysilane, ethyl-trimethoxysilane, ethyl-triacetoxysilane, propyl-trimethoxysilane, diisopropyl-dimethoxysilane, chloroisobutyl-methyl-dimethoxysilane, trifluoropropyl-trimethoxysilane, trifluoropropyl-methyl-dimethoxysilane, isobutyl-trimethoxysilane, n-butyl-trimethoxysilane, n-butyl-methyl-dimethoxysilane, phenyl-trimethoxysilane, phenyl-methyl-dimethoxysilane, triphenyl-silanol, n-hexyl-trimethoxysilane, n-octyl-trimethoxysilane, isooctyl-trimethoxysilane, decyl-trimethoxysilane, hexadecyl-trimethoxysilane, cyclohexyl-methyl-dimethoxysilane, cyclohexyl-ethyl-dimethoxysilane, octyl-cyclopentyl-dimethoxysilane, tert. butyl-ethyl-dimethoxysilane, tert. butyl-propyl-dimethoxysilane, dicyclohexyl-dimethoxysilane, mercaptopropyl-trimethoxysilane, mercaptopropyl-methyl-dimethoxysilane, bis(triethoxysilyl-propyl)disulfide, bis(triethoxysilyl-propyl)tetrasulfide, aminopropyl-trimethoxysilane, m-aminophenyl-trimethoxysilane, aminopropyl-methyl-diethoxysilane, phenyl-aminopropyl-trimethoxysilane, aminoethyl-aminopropyl-trimethoxysilane, aminoethyl-aminopropyl-methyl-dimethoxysilane, glycidoxypropyl-trimethoxysilane, glycidoxypropyl-methyl-dimethoxysilane, epoxycyclohexyl-ethyl-trimethoxysilane, y-methacryl-oxypropyl-triacetoxysilane, vinyl-triacetoxysilane, vinyl-trimethoxysilane, methyl-vinyl-dimethoxysilane, vinyl-dimethyl-methoxysilane, divinyl-dimethoxysilane, vinyl-tris(2-methoxyethoxy)silane, hexyl-trimethoxysilane, y-methacryl-oxypropyl-trimethoxysilane, acryl-oxypropyl-trimethoxysilane, vinyl-benzyl-ethyl-endiaminpropyl-trimethoxysilane, vinyl-benzyl-ethyl-endiaminpropyl-trimethoxysilane hydrochloride, allyl-ethyl-endiaminpropyl-trimethoxysilane, allyl-trimethoxysilane, allyl-methyl-dimethoxysilane, allyl-dimethyl-methoxysilane, and hexyl-trimethoxysilane, methyl-trimethoxysilane, trimethyl-methoxysilane, dimethyl-dimethoxysilane, trimethyl-chlorosilane, ethoxytrimethyl-silane, vinyl-trimethoxysilane, trimethyl-chlorosilane, trichlorosilane, bromtrimethyl-silane, octamethyl-trisiloxane, tetramethyl-disiloxane, hexamethyl-disiloxane. Those reagents can be used on their own or mixed in any way.

The nanoparticles' modification on the basis of silicon dioxide or aluminum oxide takes place in, for example, an aqueous or organic medium.

The silanizing reagents are therein brought to react with the particles in an organic or aqueous medium.

According to an advantageous embodiment variant of the invention, the reaction is engineered such that as quantitative as possible surface saturating takes place and the nanoparticles' reactivity is decisively reduced thereby.

According to an embodiment variant, the nanoparticles' surfaces have been modified such that the impregnating resins filled therewith exhibit a monodisperse nanoparticle distribution.

According to another embodiment variant, the nanoparticles have a primary grain size of under 50 nm.

The filled impregnating resin's low initial viscosity is achieved by using the coated particles in a low-viscosity aromatic epoxy resin, preferably an epoxy resin having a viscosity of less than 120 mPas, preferably less than 90 mPas, and particularly preferably of 60 mPas, for example at 60° C., on the basis of BFDGE and/or BADGE (bisphenol-A-diglycidyl-ether and/or bisphenol-F-diglycidyl-ether).

According to a preferred embodiment variant, a reactive thinner is added to the low-viscosity aromatic epoxy resin. The reactive thinner is added preferably in an amount ranging from 1 to 20% by volume, particularly preferably in the range of 2 to 15% by volume, and quite especially in the range of 2 to 10% by volume.

A method for incorporating the coated particles that only slightly encumbers the overall matrix is also advantageously selected. For example the epoxy resin is stirred into the nanoparticulate filler mixture, which filler is present in a solvent, for example an organic one. The organic solvent is then separated off under reduced pressure by means of distillation either at a reduced temperature, by spray drying, and/or by thin-film distillation.

Thanks to the inventive use of coated nanoparticles in impregnating resins for producing mica-based high-voltage insulators it is possible to realize high-voltage insulators having hitherto unachieved properties:

Firstly, increasing the insulators' electric strength compared with the prior art (for example Micalastic) by a factor of >5. Characterizing is performed on wound transposed conductors or coils my means of electric life tests at test voltages of 2 UN to 4 UN. This makes it possible to verify the increased service life at the rated voltage while the generator/motor is operating.

Alongside the above, there is adequate storage stability that will allow multiple use of nanoparticulate impregnating resins for impregnating mica-based insulators. This is achieved through a viscosity that is low as well as constant throughout a number of impregnating operations and which requires only the addition of new impregnating resin equaling the amount consumed during each impregnating process. The relevant volume corresponds per impregnating process to approximately 1 to 5% of the overall volume of impregnating resin. The primary grain size of the SiO₂ particles is preferably below 50 nm. The good storage stability—for example storing the nanoparticles/epoxy resin/anhydride mixture at 70° C. results in a maximum viscosity value of 300 mPas after 10 days—is accompanied by low system reactivity in the absence of catalysts.

Finally, it is specifically the low initial viscosity of, for example, <60 mPas at 60° C. that is achieved by the nanoparticles' coating and their use of BFDGE and/or BADGE possibly in combination with reactive thinners such as glycidyl-ether. Other examples of reactive thinners are:

Hexanediol-1,6-diglycidyl-ether, diglycidyl ester of hexahydrophthalic acid, 2-ethyl-hexyl-glycidyl-ether, 1,4-butane diglycidyl-ether, trimethyl-olpropane-triglycidyl-ether, polypropylene glycoldiglycidyl-ether.

### BRIEF DESCRIPTION OF THE DRAWINGS

FIG. 1 shows the life curves for high-voltage insulating systems that are non-filled and have a nanoparticulate filler.

FIG. 2 compares the storage stability of selected systems based on BFDGE with and without the addition of BYK 985.

FIGS. 3 and 4 show the initial viscosity of produced composites and the storage stability of different composites based on BFDGE in the blend with MHHPA.

### DETAILED DESCRIPTION OF INVENTION

### Exemplary embodiments

The potential of nanotechnology is shown in the use of nanoparticulate fillers in combination with the insulating materials currently employed based on mica. The life of sample bodies used for the trial, which correspond in reduced form to the prior art in terms of insulated copper conductors in stators of hydro-electric or turbo generators, is for that purpose measured under an electric field load until electric breakdown occurs. Because the insulating system's electric strength endures over several decades under an operational load, the continuous electric tests are performed at electric field strengths several times normal. The graphic below shows the mean values of the electric life of in each case seven sample bodies at three different field loads for in each case a standard insulating system (mica) and an insulating system having a nanoparticulate filler (NanoIso).

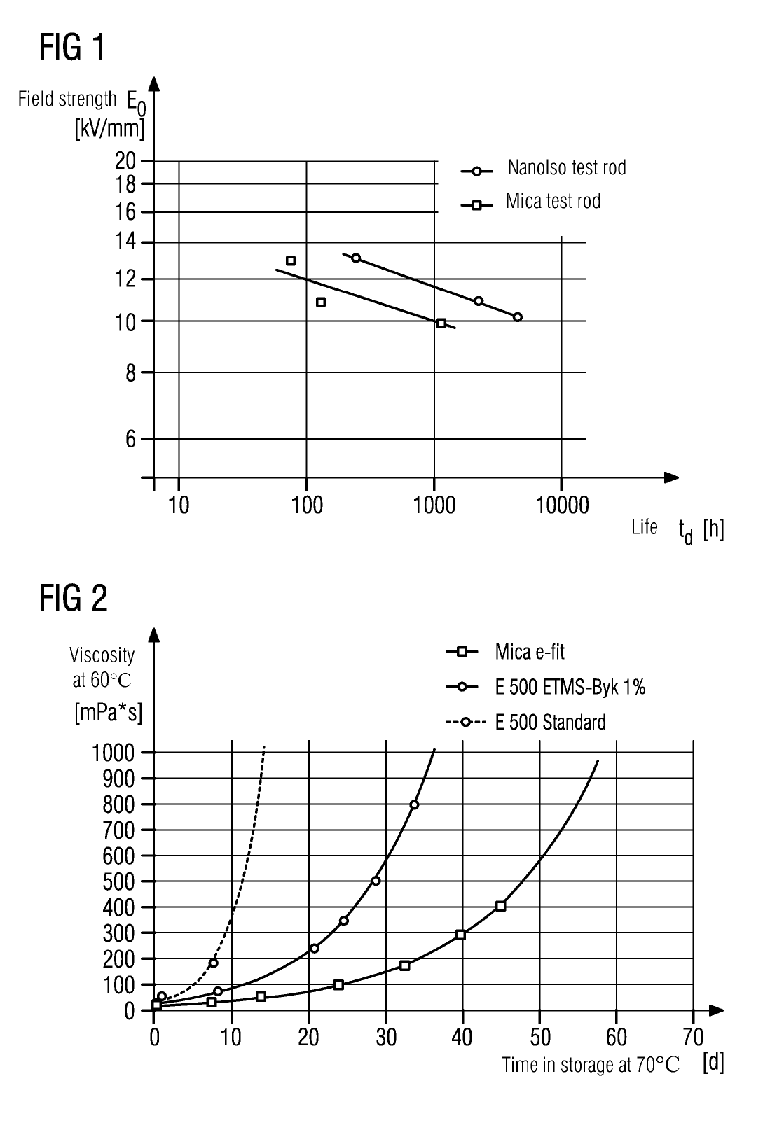

FIG. 1 shows the life curves for high-voltage insulating systems that are non-filled and have a nanoparticulate filler.

Comparing the life of the respective aggregates shows service life improved by a factor of 5 to 10. Since the same increase is displayed by both life curves, it seems permissible to transpose the life extension directly to operational conditions.

That is possible only with impregnating resins exhibiting low initial viscosity and good storage stability (stored at 70° C.).

Alongside the reduction in reactivity, storage stability can also be positively influenced by a reduction in initial viscosity. Various coating measures are available for that purpose. Shown in FIG. 5 are the effects on the viscosity curve of an initial viscosity that was reduced by using bisphenol-F-diglycidyl-ether (BFDGE) to replace BADGE employed hitherto as standard. It was incorporated in the following form:
Nanopox from the company Nanoresins E500 (37.5% by weight SiO₂, 25 nm, in BFDGE)
Vacuum and temperature drying
Saturating with monofunctional silanes (e.g. ETMS)
1% BYK-W 985

FIG. 2 compares the storage stability of selected systems based on BFDGE with and without the addition of BYK 985.

Comparing the graphs shows that using nanoparticulate BFDGE (Nanopox E 500) produces the expected reduction in initial viscosity and that a 28-day storage stability (reference 3500 mPas) is attained through drying, saturating with ETMS, and then adding BYK-W 985.

The nanocomposites (SiO₂, 10 nm) produced based on BFDGE or BADGE are characterized by low initial viscosity and a low level of reactivity in the blend with the hardener.

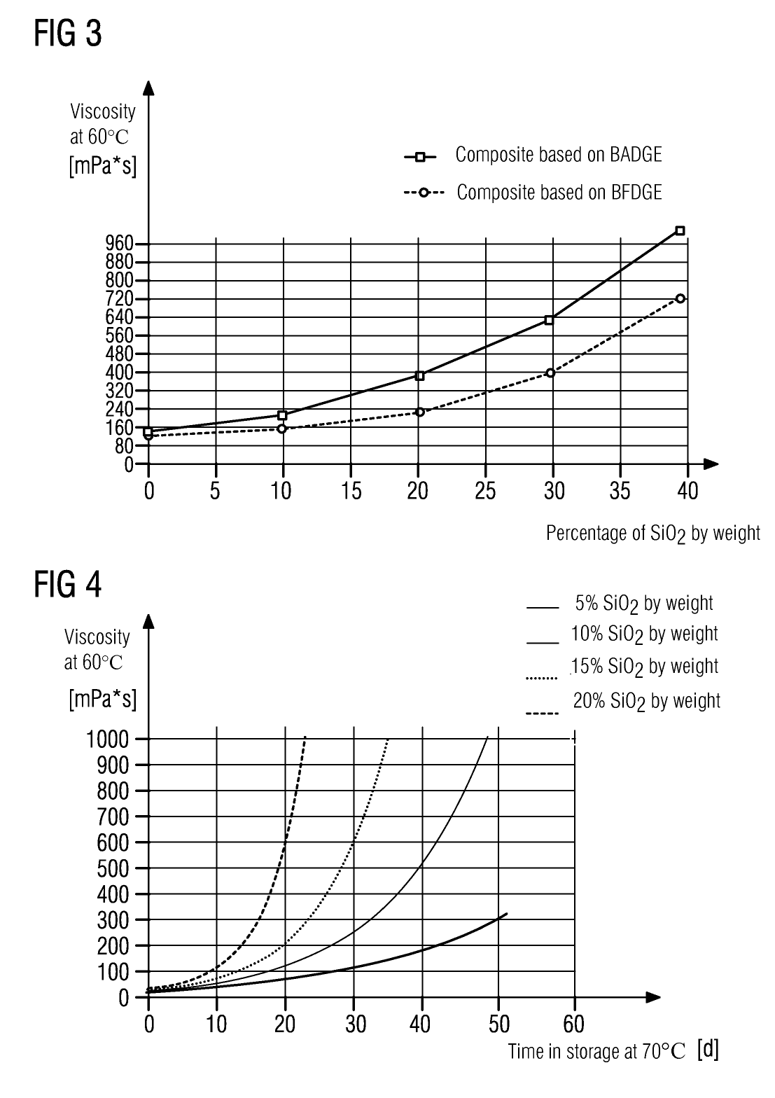

FIGS. 3 and 4 show on the one hand the initial viscosity of produced composites and, on the other, the storage stability of different composites based on BFDGE in the blend with MHHPA.

The invention relates to an insulation for rotating electric machines on the basis of low-viscosity aromatic epoxy resins based on BFDGE or BADGE as the impregnating-resin matrix with a nanoparticulate filler. According to the invention the nanoparticulate filler is harmonized with the resin matrix in terms of reactivity, viscosity, and grain size so that the reaction mechanism in force during polymerization will at least not be stimulated by the nanoparticles.

1.-7. (canceled)

8. A mica-based impregnating resin comprising an epoxy resin/anhydride mixture and a nanoparticulate filler, wherein the nanoparticulate filler is a nanoparticulate silicon dioxide and/or aluminum oxide modified by a silanizing reagent.

9. The impregnating resin as claimed in claim 8, with an epoxy resin/anhydride mixture containing an nanoparticulate filler in the amount of 3 to 60% by weight.

10. The impregnating resin as claimed in claim 8, with BFDGE or BADGE being used, with a reactive thinner having been added.

11. The impregnating resin as claimed in claim 8, with a reactive thinner having been added in an amount ranging from 1 to 20% by volume.

12. The impregnating resin as claimed in claim 8, with the silanizing reagent being a compound selected from the group consisting of: Trimethyl-methoxysilane, methyl-hydrogendimethoxysilane, dimethyl-dimethoxysilane, ethyl-trimethoxysilane, ethyl-triacetoxysilane, propyl-trimethoxysilane, diisopropyl-dimethoxysilane, chloroisobutyl-methyl-dimethoxysilane, trifluoropropyl-trimethoxysilane, trifluoropropyl-methyl-dimethoxysilane, isobutyl-trimethoxysilane, n-butyl-trimethoxysilane, n-butyl-methyl-dimethoxysilane, phenyl-trimethoxysilane, phenyl-methyl-dimethoxysilane, triphenyl-silanol, n-hexyl-trimethoxysilane, n-octyl-trimethoxysilane, isooctyl-trimethoxysilane, decyl-trimethoxysilane, hexadecyl-trimethoxysilane, cyclohexyl-methyl-dimethoxysilane, cyclohexyl-ethyl-dimethoxysilane, octyl-cyclopentyl-dimethoxysilane, tert. butyl-ethyl-dimethoxysilane, tert. butyl-propyl-dimethoxysilane, dicyclohexyl-dimethoxysilane, mercaptopropyl-trimethoxysilane, mercaptopropyl-methyl-dimethoxysilane, bis(triethoxysilyl-propyl)disulfide, bis(triethoxysilyl-propyl)tetrasulfide, aminopropyl-trimethoxysilane, m-aminophenyl-trimethoxysilane, aminopropyl-methyl-diethoxysilane, phenyl-aminopropyl-trimethoxysilane, amino ethyl-aminopropyl-trimethoxysilane, aminoethyl-aminopropyl-methyl-dimethoxysilane, glycidoxypropyl-trimethoxysilane, glycidoxypropyl-methyl-dimethoxysilane, epoxycyclohexyl-ethyl-trimethoxysilane, y-methacryl-oxypropyl-triacetoxysilane, vinyl-triacetoxysilane, vinyl-trimethoxysilane, methyl-vinyl-dimethoxysilane, vinyl-dimethyl-methoxysilane, divinyl-dimethoxysilane, vinyl-tris(2-methoxyethoxy)silane, hexyl-trimethoxysilane, y-methacryl-oxypropyl-trimethoxysilane, acryl-oxypropyl-trimethoxysilane, vinyl-benzyl-ethyl-endiaminpropyl-trimethoxysilane, vinyl-benzyl-ethyl-endiaminpropyl-trimethoxysilane hydrochloride, allyl-ethyl-endiaminpropyl-trimethoxysilane, allyl-trimethoxysilane, allyl-methyl-dimethoxysilane, allyl-dimethyl-methoxysilane, and hexyl-trimethoxysilane.

13. A method of producing a mica-based impregnating resin as claimed in claim 8, the method comprising:
adding the epoxy resin to a nanoparticulate filler mixture, which includes the silanizing agent and the filler in a solvent,
separating the solvent under reduced pressure by distillation at a reduced temperature and/or by spray drying and/or by thin-film distillation.

14. An electric machine comprising a mica-based impregnating resin as claimed in claim 8, wherein the impregnating resin is used for insulating the electric machine.
